(19) United States
(12) Patent Application Publication
(10) Pub. No.: US 2018/0129368 A1
(43) Pub. Date: May 10, 2018

(54) DATA CHARACTERISTIC GUIDED FILTER BUILDER

(71) Applicant: Microsoft Technology Licensing, LLC, Redmond, WA (US)

(72) Inventors: Chiu Ying Cheung, Redmond, WA (US); Taurean Jones, Issaquah, WA (US); Andrei Liakhovich, Redmond, WA (US)

(21) Appl. No.: 15/345,382

(22) Filed: Nov. 7, 2016

(51) Int. Cl. G06F 3/0482; G06F 3/0486; G06T 11/20; G06F 3/0484; G06F 17/24; G06F 17/30; G06F 7/10

(52) U.S. Cl. CPC G06F 3/0482; G06F 3/0486; G06T 11/206; G06F 17/30554; G06F 17/245; G06F 17/30315; G06F 7/10; G06F 3/04845

(57) ABSTRACT

A filter builder is data characteristic guided. A data characteristic can be determined that describes data or the distribution thereof. A visualization of the data characteristic can be generated and displayed. A selection signal from an input device can be received selecting one or more elements of visualizations. Based on one or more selected elements, a filter condition can be generated automatically and presented in the same context with the visualizations.

### BACKGROUND

Vast amounts of data are collected and utilized for a variety of purposes. However, data sets can include incomplete, inaccurate, and/or irrelevant data. Accordingly, a data set is typically transformed or refined prior to use for a particular purpose. A data set can be transformed with filters that identify data to include or exclude. The transformation process is cyclic, wherein a filter is manually specified, filtered data is retrieved and analyzed, and a new or modified filter is specified that further refines the data. Many iterations of the cycle are often required to locate an appropriately filtered data set.

### SUMMARY

The following presents a simplified summary in order to provide a basic understanding of some aspects of the disclosed subject matter. This summary is not an extensive overview. It is not intended to identify key/critical elements or to delineate the scope of the claimed subject matter. Its sole purpose is to present some concepts in a simplified form as a prelude to the more detailed description that is presented later.

Briefly described, the subject disclosure pertains to data characteristic guided filter building. Data characteristics, which describe data including the distribution thereof, can be automatically determined from a data set and subsequently visualized and made available for interaction. A selection signal can be received from an input device selecting one or more elements of the visualization. One or more filter conditions can be automatically generated based on the selected one or more elements. Next, the one or more generated filter conditions can be presented in a work area in context with the data visualizations.

To the accomplishment of the foregoing and related ends, certain illustrative aspects of the claimed subject matter are described herein in connection with the following description and the annexed drawings. These aspects are indicative of various ways in which the subject matter may be practiced, all of which are intended to be within the scope of the claimed subject matter. Other advantages and novel features may become apparent from the following detailed description when considered in conjunction with the drawings.

### BRIEF DESCRIPTION OF THE DRAWINGS

FIG. 1 is a block diagram of a filter builder system.

FIG. 2 is a block diagram of a representative user interface component.

FIG. 3 is a block diagram of a representative data visualization component.

FIG. 4 is a screenshot of an exemplary user interface.

FIG. 5 is a screenshot of an exemplary user interface with data visualizations embodied as bar graphs of frequency distribution.

FIG. 6 is a screenshot of an exemplary user interface including selection of visual elements and presentation of filter conditions.

FIG. 7 is a screenshot of an exemplary user interface including selection of a column and presentation of a filter condition.

FIG. 8 is a screenshot of an exemplary user interface illustrating column exclusion.

FIG. 9 is a screenshot of an exemplary user interface illustrating data exclusion.

FIG. 10 is a flow chart diagram of a method of filter building.

FIG. 11 is a flow chart diagram of a method of building a filter.

FIG. 12 is a flow chart diagram of a method of filtering building.

FIG. 13 is a flow chart diagram of a feedback method.

FIG. 14 is a schematic block diagram illustrating a suitable operating environment for aspects of the subject disclosure.

### DETAILED DESCRIPTION

Data set refinement can involve utilization of filters to remove irrelevant or other data from a data set, for example to facilitate data analysis and reporting, among other uses. Conventionally, determining which data from a data set should be included or excluded in a filtered result is a laborious task. The process is both inefficient and error prone in that it involves a lot of back and forth in which a filter is specified, filtered results are analyzed, and a new filter specified to include or exclude data based on the analysis of the filtered results. One factor contributing to issues with the process is a lack of knowledge of data comprising a data set. For example, filters are typically specified in terms of columns with respect to a tabular data set. However, column names typically provide little, if any, assistance with respect to the data included in a column.

Details below generally pertain to data characteristic guided filter building. Data subject to filtering is automatically analyzed to determine various characteristics of the data, or a data profile. Subsequently, data characteristics can be visualized and utilized to guide a decision regarding what data to include or exclude. Filter conditions can be automatically generated based on interaction with a visualization, wherein interaction can correspond to selection of data for inclusion or exclusion in a filtered result. By way of example, columns of data can be presented with visualizations, such as graphs, that captures a characteristic of data in each column, such as the distribution frequency of unique values. One or more values in a column or entire columns can subsequently be selected, and, based on the selection, one or more filter conditions can be generated that captures the intent to include or exclude data expressed by the selection. Provisioning data characteristics and enabling selection of data in the same context significantly reduces the time and effort required to produce accurate and arbitrarily complex data filters and ultimately locate relevant information from a data set.

Various aspects of the subject disclosure are now described in more detail with reference to the annexed drawings, wherein like numerals generally refer to like or corresponding elements throughout. It should be understood, however, that the drawings and detailed description relating thereto are not intended to limit the claimed subject matter to the particular form disclosed. Rather, the intention is to cover all modifications, equivalents, and alternatives falling within the spirit and scope of the claimed subject matter.

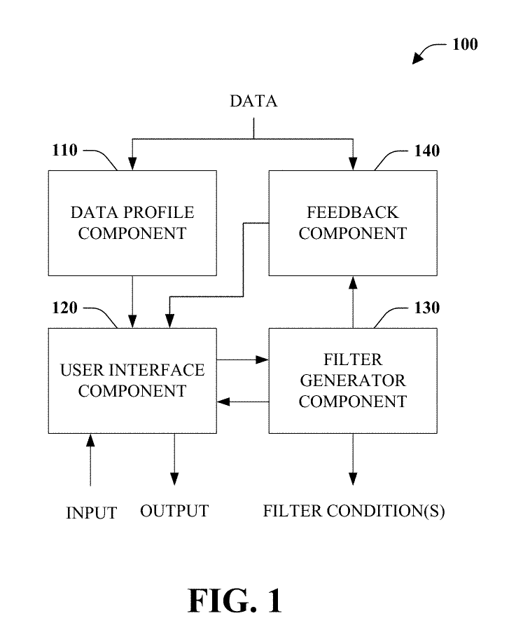

Referring initially to FIG. 1, a filter builder system 100 is illustrated. The filter builder system 100 enables data refinement by way of filter specification guided by data characteristics. A data set subject to refinement or filtering is received as input to the filter builder system 100, and one or more filter conditions are produced as output by the filter builder system 100. The one or more filter conditions can subsequently be applied to the data set to deliver refined or filtered data suited for a particular purpose. Moreover, the filter builder system 100 can facilitate filter specification by automatically providing information regarding the data set and enabling conditions to be selected based on the information. As a result, the filter builder system 100 speeds up and improves the data refinement process. The filter builder system 100 comprises data profile component 110, user interface component 120, filter generator component 130, and feedback component 140.

The data profile component 110 is configured to receive, retrieve, or otherwise obtain or acquire a data set and automatically determine one or more characteristics of the data, or a data profile. More specifically, the data profile component 110 can determine an attribute, property, quality, or feature that is descriptive of a data set including the shape of data, which is a description of the distribution or pattern of data within a data set. A variety of known and new algorithms can be employed in this regard. In one instance, data profile component 110 can determine the distribution frequency of unique or distinct values in a data set. For example, the data profile component 110 can be configured to generate a frequency table that identifies unique data values and a count identifying the number of occurrences of each unique data value. In another instance, string length can be determined for string values. With respect to patterns or semantics, the data profile component 110 can be configured to determine if values correspond to a phone number (e.g., ten-digit number), social security number (e.g., nine-digit number), zip code (e.g., five-digit number), or geographical location (e.g., latitude and longitude), among other things. Further, combinations can be employed. For example, phone numbers can be identified and distribution frequency determined for distinct phone numbers. Data characteristics, or a data profile, generated by the data profile component 110 can be received, retrieved, or otherwise obtained or acquired by the user interface component 120.

The user interface component 120 enables interaction in connection with data refinement and employs data characteristics to provide helpful insight into a data set. Output of the user interface component 120 can include graphics, text, audio and/or video, among other things, associated with a data set and filtering thereof. Input to the user interface component 120 can comprise a selection signal from an input device (e.g., mouse, touchscreen, camera, microphone . . . ) identifying data to include or exclude in a filtered result. Further, the user interface component 120 can interact with the filter generator component 130 to acquire filter conditions and the feedback component 140 to provide feedback with respect to the effect of selection of particular data.

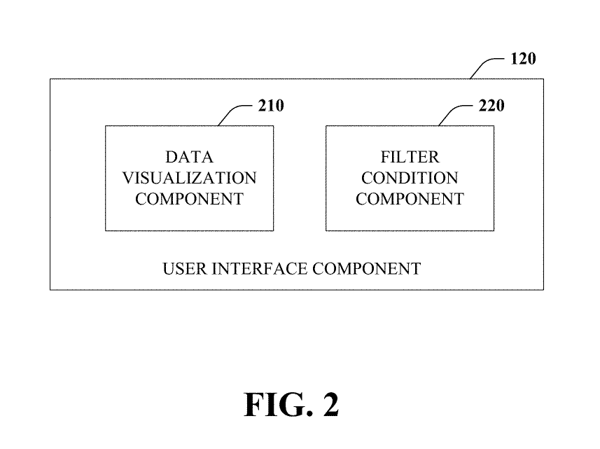

Turning attention briefly to FIG. 2, a representative user interface component 120 is illustrated in further detail comprising a data visualization component 210, and filter condition component 220. The data visualization component 210 is configured to produce visualizations of data characteristics to aid users in decisions regarding including data in and excluding data from a data set. While the data visualization component 210 can visualize a preview of raw data in a data set, such a preview is not typically very helpful for a variety of reasons associated with the shape of data (e.g., first hundred rows of a column could be empty) and sampling, among other things. Additionally or alternatively, the data visualization component 210 can go a step further in visualizing characteristics of a data set. Stated differently, the data visualization component 210 can visualize data about data, or metadata, as opposed to simply the data itself. The filter condition component 220 can present filter conditions or criteria that correspond to selection of elements of visualized data characteristics. In one particular instance, the filter conditions can be presented in the same context as visualizations of the data characteristics. In other words, filter conditions and data characteristics can appear in the same window, or like independent display area, such that a user need not switch visual context to another window, or tab within a single window, to view one of the filter conditions or data characteristics.

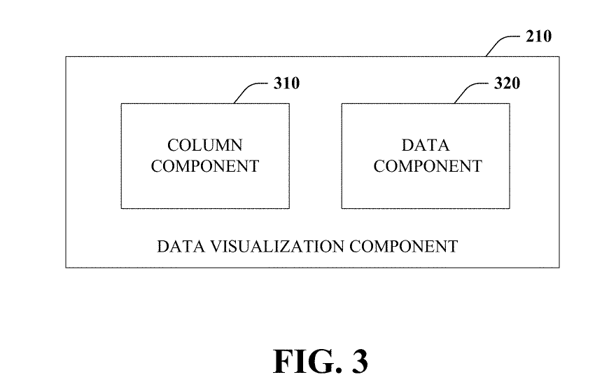

Referring to FIG. 3, a representative data visualization component 210 is depicted in further detail including column component 310 and data component 320. Tabular data includes columns that comprise a set of data values for each row in a table. The column component 310 is configured to provide visualization of one or more columns so as to differentiate one column from another column visibly. The data component 320 is configured to generate visualizations that capture data characteristics for each column of data. In one instance, a column visualization produced by the column component 310 can act as a container that can include a data characteristic visualization generated by the data component 320. For example, a column visualization can include a graph (e.g., bar, pie, histogram . . . ) that captures distribution frequency of unique data values in the column. This provides a high-level preview of the shape of the data in a column that helps guide a decision of whether or not to include or exclude the column or portions thereof. Further, such visualizations facilitate creation of cross column filters rather than requiring fall back to code to specify conditions.

Returning to FIG. 1, the user interface component 120 can receive a selection signal as input selecting an entire column or elements of the visualization within the column to keep or exclude. Selected elements are received, retrieved, or otherwise obtained or acquired by the filter generator component 130. The filter generator component 130 determines one or more filter conditions that correspond to the selected elements and communicates the one or more filter conditions back to the user interface component 120, which can display the one or more filter conditions in a visual work area or canvas, for example. The filter generator component 130 can also output these filter conditions in a general or syntax specific form for use in building a query (e.g., within a WHERE clause), for instance. As a simple example, selection of a distinct element in a data visualization of a data characteristic in a column can result in a filter condition that states the column equals the distinct element value (e.g., inclusive) or the column does not equal the distinct element value (e.g., exclusive). Arbitrarily complex filter conditions can be created across multiple columns combined or related with logical operators (e.g., AND, OR . . . ). Multiple filter conditions related by at least one logical operator may be referred to as a filter expression or filter conditions.

The feedback component 140 is configured to determine and provide information about the effects of user selection actions to the user interface component 120 for display. The feedback component 140 receives, retrieves, or otherwise obtains or acquires data from a data set as well as filter conditions from the filter generator component 130. This data can be utilized to provide different types of feedback. In one instance, the feedback component 140 can determine how selection of a value in one column effects data and an associated visualization in a second column. For instance, if a value in a first column is selected for exclusion, a determination is made as to how that would affect rows within a second column. For example, exclusion of a value in a first column may eliminate some values in a second column, which can be communicated to the user interface component 120 to allow the visualization to be altered to reflect the effect. More specifically, values in the second column would that form part of a row that includes the excluded value in the first column would be eliminated. In another instance, the feedback component 140 can determine how many rows or records are included or excluded from a result set by one or more filter conditions. By way of example, it can be determined that a first condition includes or excludes a number of records from a total number of records, and such information can be communicated to the user interface component 120 for inclusion in proximity to the filter condition (e.g. next to, below, above) in a work area. Feedback information including, but not limited to, that described above provides further insight into a data set and facilitates accurate specification of filter conditions to refine a data set.

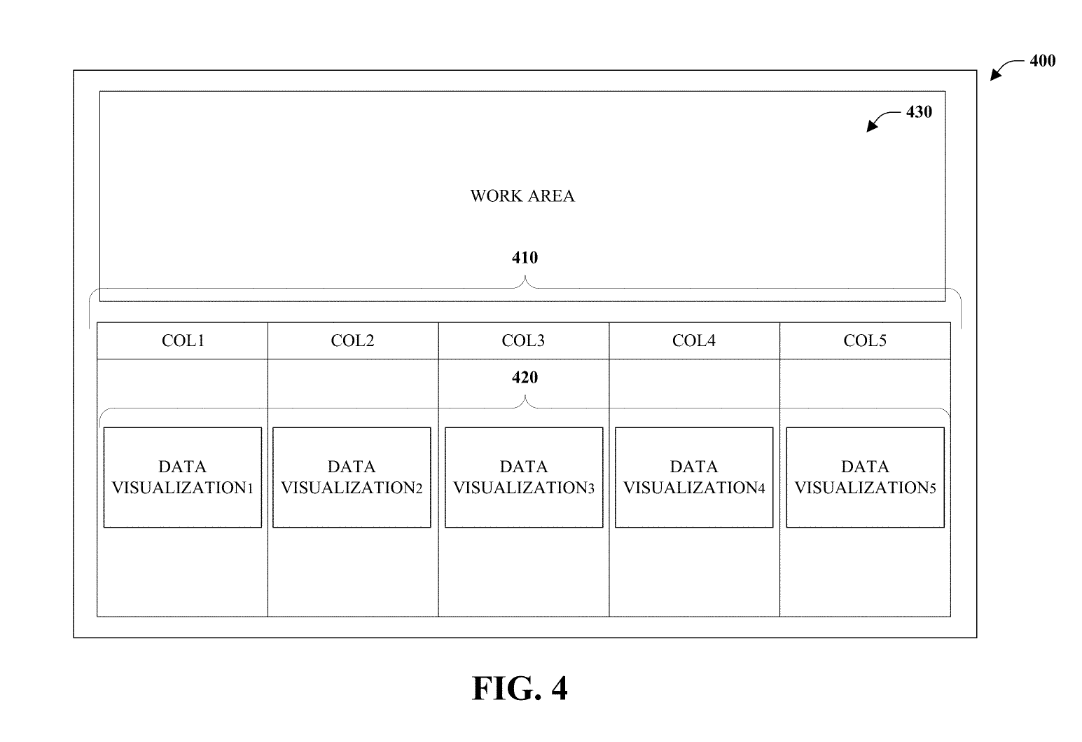

FIGS. 4-9 provide a number of screenshots that can be generated by the user interface component 120 of FIG. 1. These screenshots are solely exemplary and are not meant in a limiting sense, but rather to aid clarity and understanding with respect to aspects of this disclosure. Various other combinations and positions of text and graphics are possible and contemplated.

Turning attention to FIG. 4, a screenshot of an exemplary user interface is depicted. The screenshot illustrates a window 400 comprising a number of column visualizations 410 (COL1-COL4) that identify particular columns of interest in a tabular data set. A subset of columns may be displayed to prevent over-crowding. In a wide data set comprising hundreds of columns, for example, a user may execute a search to locate a subset of columns with which the user desires to work. The column visualizations 410 act as containers for corresponding data visualizations 420 (DATA VISUALIZATION1-DATA VISUALIZATION5). The data visualizations 420 depict a characteristic that describes data of a corresponding column of tabular data set. For example, the data visualizations can capture data shape, and more specifically a description of the distribution of data or pattern of data within a dataset. The data visualizations 420 can take substantially any form including graphs (e.g., bar, pie, histogram . . . ), timelines, or maps, among others. The window 400 also includes a work area 430 for display and interaction with automatically generated filter conditions or expressions. For instance, selection of an element of a data visualization for inclusion or exclusion from a filtered result set, would result in a corresponding filter condition being generated and displayed in the work area 430. After display, a filter condition need not be fixed but rather can be subject to alteration within the work area 430. For example, an inclusive filter condition specifying “Equals” can be changed to an exclusive filter condition specifying “Not Equals.”

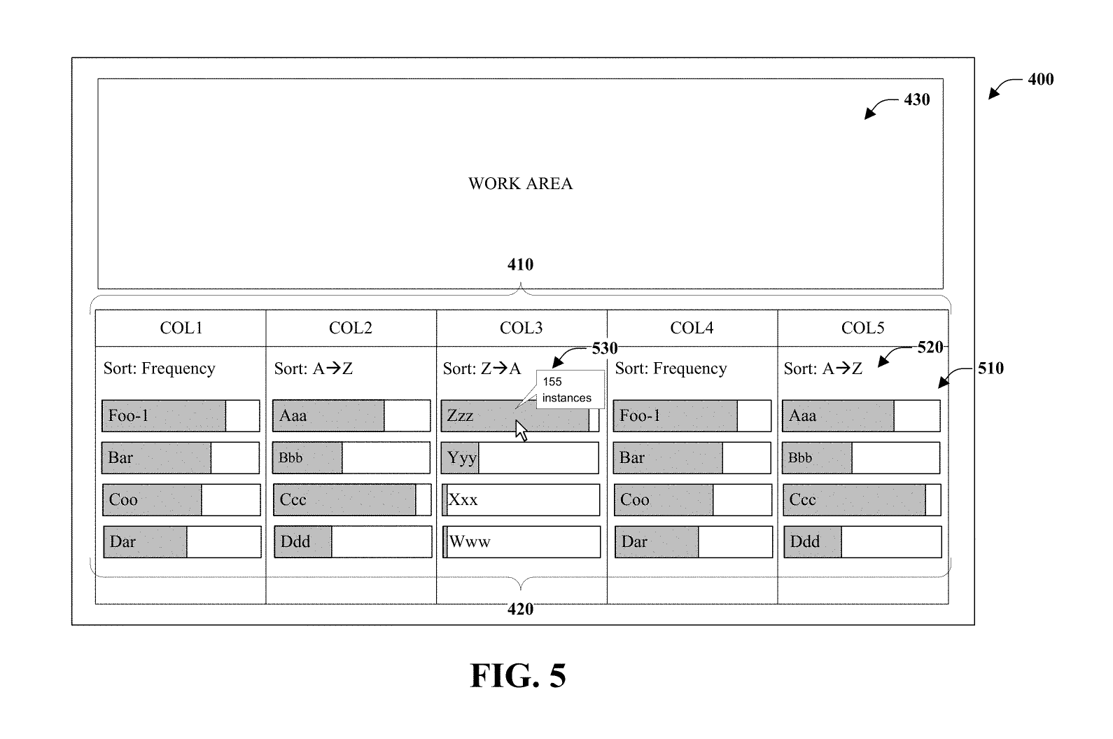

FIG. 5 is a screenshot depicting another exemplary user interface in further detail. Similar to FIG. 4, the screenshot shows the window 400, the column visualizations 410 and the data visualizations 420 embedded within corresponding column visualizations 410. Here, however, the data visualizations 420 are embodied as bar graphs 510 illustrating the relative frequency distribution of unique data values in each column. The data visualization 420 further includes sort 520, which is an interactive element that enables the graphical data to be sorted. For instance, a user can indicate that the data be sorted by frequency (highest-to-lowest or lowest-to-highest) or alphabetically (A->Z or Z->A). Although not illustrated other mechanisms can be made available like search functionality to allow identification of unique values of interest, which is especially useful when there are a large number of unique values. The graphical visualization of distribution frequency allows a user to quickly understand the shape of data distribution including how the data is skewed and where the tail resides. For example, in “COL1” the graph indicates that “Foo-1” occurs more often that “Bar,” which occurs more often that “Coo” and “Dar.” Further, hint 530 can be presented upon hovering a pointer or the like over a graphical element to identify the number of instances of a particular value. The width of the bars of the graph provide an idea of proportionality. For instance, there is quite a difference between the first and the last two values in “COL3.” However, the hint 530 drills down and identifies the number of unique instances, namely 155.

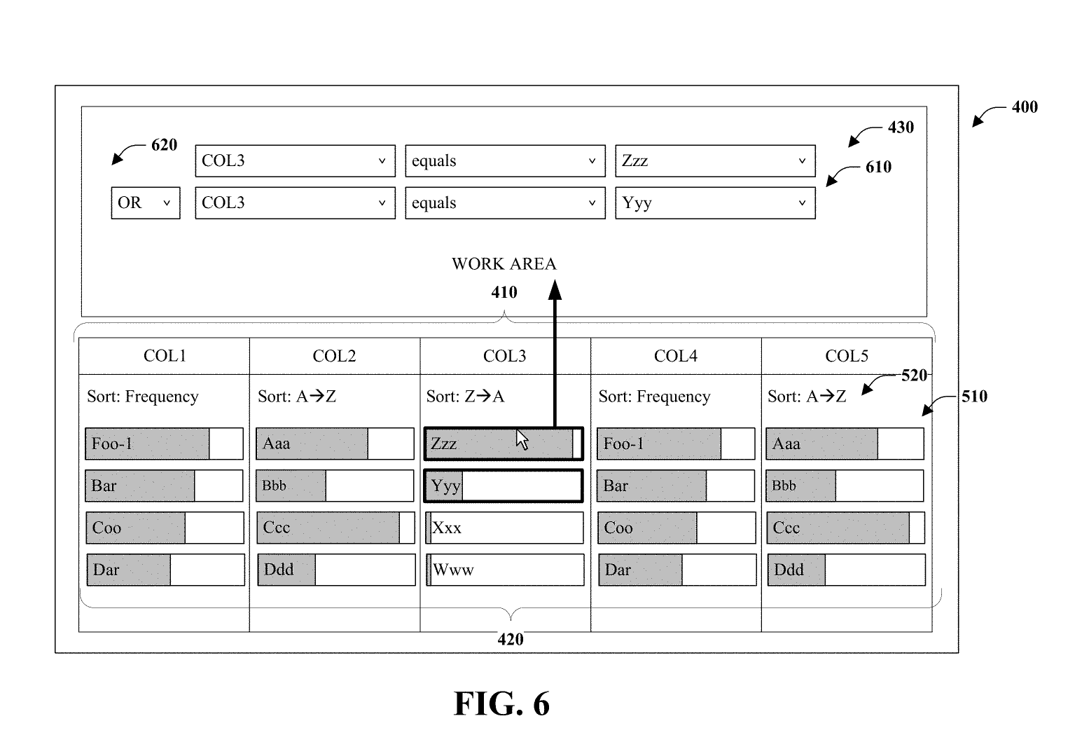

FIG. 6 is a screenshot of another exemplary user interface. As in FIG. 5, the screenshot includes the window 400, column visualizations 410 including embedded data visualizations 420, wherein the data visualizations are embodied as bar graphs 510 identifying frequency distribution, and an interactive sort mechanism sort 520. Depicted in FIG. 6 is selection of data for inclusion in a filtered result. As shown in bold, two elements of the visualizations, namely the first to unique values in “COL3,” (“Zzz” and “Yyy”), have been selected or multi-selected. Although not limited thereto, in accordance with one embodiment, selection involves dragging and dropping the elements to the work area 430, as indicated by the arrow from the data elements to the work area 430. Selection of these elements results in the automatic generation of filter conditions 610. In particular, the filter conditions 610 indicate that “COL3” equals “Zzz” and “COL3” equals “Yyy.” Also displayed is an interactive element for setting a logical operator 620 to specify or change the relationship between the filter conditions. The logical operator 620 is currently set automatically to “OR” to indicate inclusion of all rows with either “Zzz” or “Yyy” in “COL3.” Note that explicit selection of included elements implies exclusion of unselected elements. Accordingly, a user may seek to exclude the last two values, “Xxx” and “Www,” of “COL3” because the values do not appear often by selecting the first two values for inclusion.

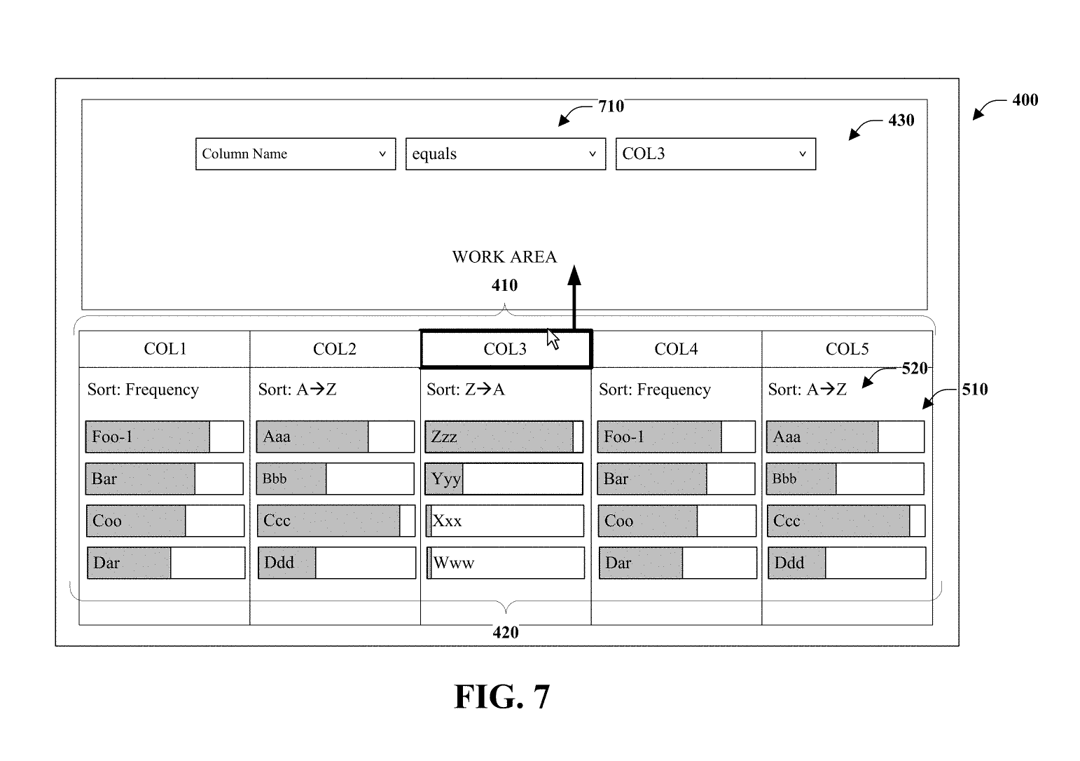

FIG. 7 is a screenshot of still another exemplary user interface. Similar to FIGS. 5 and 6, the screenshot comprises the window 400, column visualizations 410 and embedded data visualizations 420 embodied as bar graphs 510 identifying frequency distribution with an interactive sort mechanism sort 520, and interactive work area 430. FIG. 6 illustrates selection of a subset of data in a column., namely particular elements of values of a column. In FIG. 7, the screenshot depicts selection of an entire column, namely “COL3,” as indicated in bold. Again, selection can correspond to the gesture of dragging and dropping the column on the work area 430. Subsequently, filter criterion 710 is automatically generated and displayed in the work area 430 to reflect the selection. In this case, the filter criterion 710 specifies that “Column Name” equals “COL3.” Resulting filtered data will include all rows with values “Zzz,” “Yyy,” “Xxx,” or “Www” in “COL3.”

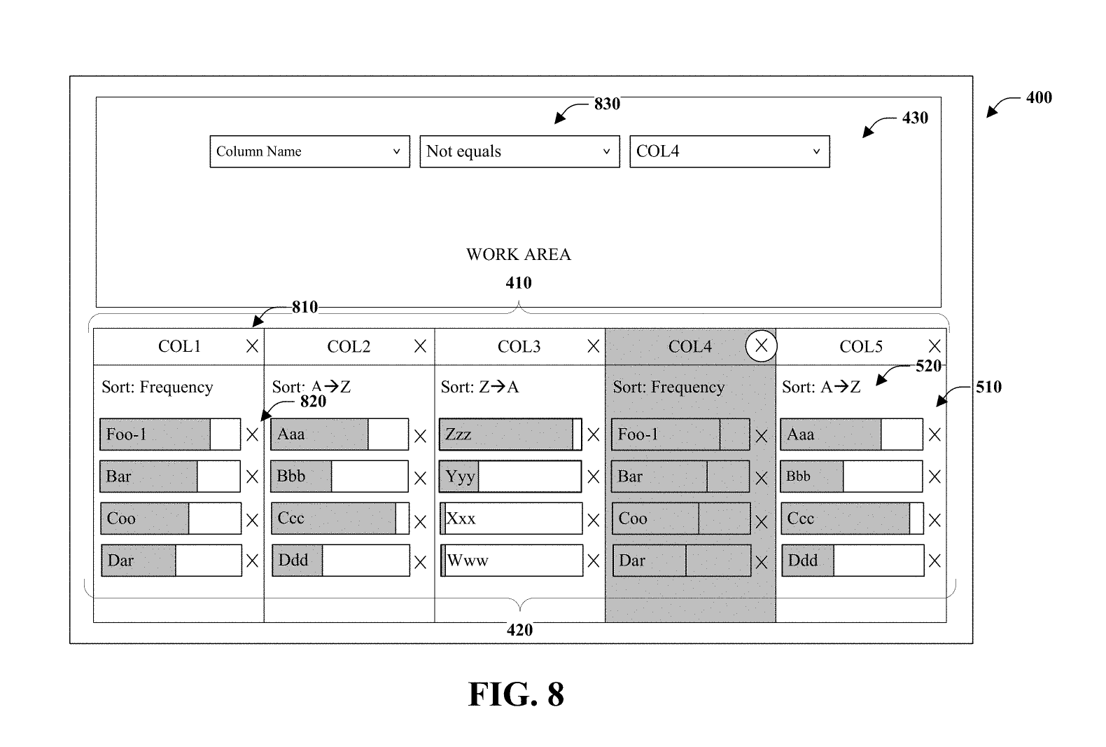

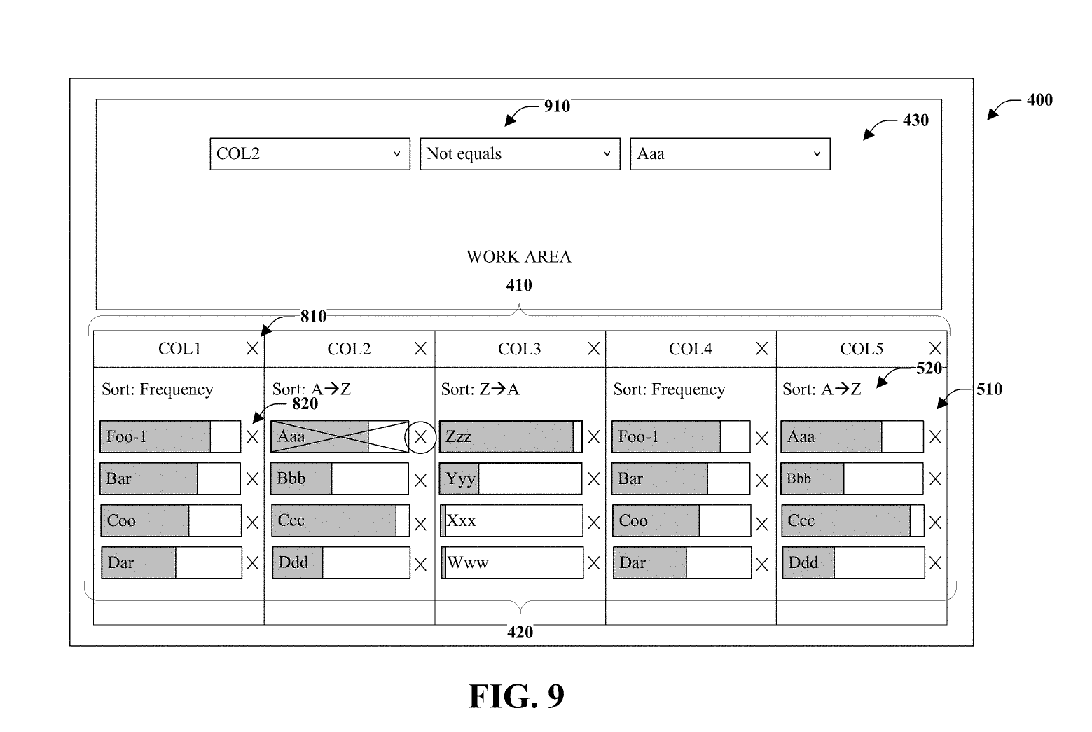

FIGS. 8 and 9 are screenshots of exemplary user interfaces associated with exclusionary filtering. Similar to previous exemplary user interfaces, FIGS. 8 and 9 include the window 400, column visualizations 410, embedded data visualizations 420 embodied as bar graphs 510 identifying frequency distribution with an interactive sort mechanism sort 520, and interactive work area 430. Additionally, the column visualizations 410 include column “X” symbols 810 and the data visualizations 420 include data “X” symbols 820. FIG. 8 depicts a scenario in which the column “X” symbol 810 of “COL4” was selected. The result of selection is generation and presentation of filter criterion 830, which indicates that “Column Name” does not equal “COL4,” which could mean the entire column is excluded from the results. Further, the column visualization 410 is shaded in grey to indicate selection and exclusion thereof. FIG. 9 is similar to FIG. 8, except that the screenshot of FIG. 9 illustrates selection of a data “X” symbol 820 rather than a column “X” symbol 810. Selection of a data “X” symbol 820 associated with a particular value in a column, here “Aaa” in “COL2,” results in generation and display of filter condition 910, which indicates “COL2” is not equal to “Aaa.” The result is that any row of data that includes “Aaa” in “COL2” will be filtered out or excluded. Additionally, the graph bar corresponding to “Aaa” in “COL2” is illustrated as crossed out to indicate selection and exclusion thereof.

The aforementioned systems, architectures, environments, and the like have been described with respect to interaction between several components. It should be appreciated that such systems and components can include those components or sub-components specified therein, some of the specified components or sub-components, and/or additional components. Sub-components could also be implemented as components communicatively coupled to other components rather than included within parent components. Further yet, one or more components and/or sub-components may be combined into a single component to provide aggregate functionality. Communication between systems, components and/or sub-components can be accomplished in accordance with either a push and/or pull model. The components may also interact with one or more other components not specifically described herein for the sake of brevity, but known by those of skill in the art.

Furthermore, various portions of the disclosed systems above and methods below can include or employ of artificial intelligence, machine learning, or knowledge or rule-based components, sub-components, processes, means, methodologies, or mechanisms (e.g., support vector machines, neural networks, expert systems, Bayesian belief networks, fuzzy logic, data fusion engines, classifiers . . . ). Such components, inter alia, can automate certain mechanisms or processes performed thereby to make portions of the systems and methods more adaptive as well as efficient and intelligent. By way of example, and not limitation, the data profile component 110 can utilize such mechanisms to infer patterns in data

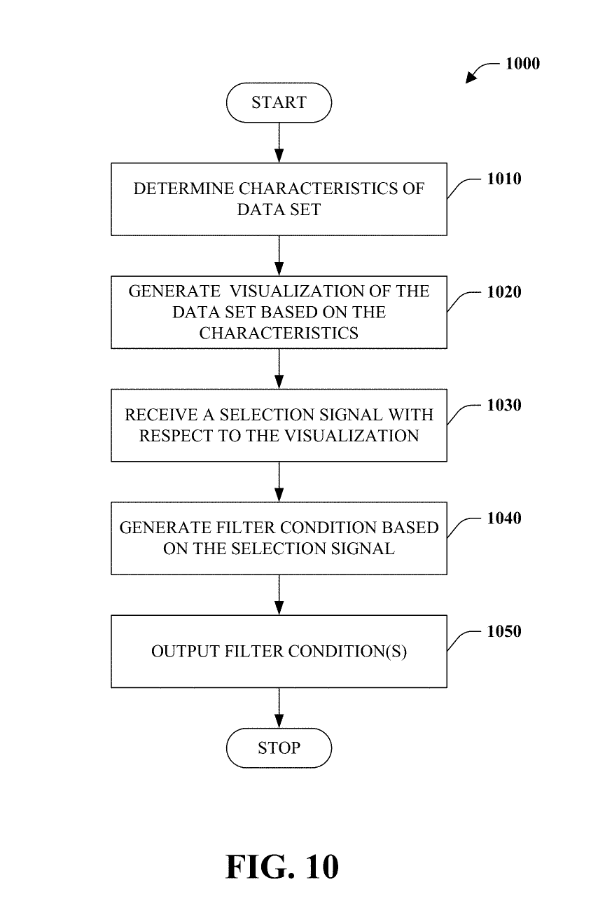

In view of the exemplary systems described above, methodologies that may be implemented in accordance with the disclosed subject matter will be better appreciated with reference to the flow charts of FIGS. 10-13. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described hereinafter.

Referring to FIG. 10, a method of filter building 1000 is illustrated. At reference numeral 1010, one or more characteristics of a data set are determined. A characteristic can correspond to any attribute, property, quality, or feature that is descriptive of a data set including the distribution or a pattern of data. For example, a characteristic can be frequency distribution of values, string length, or classification as time, phone number, or zip code, among others.

At reference numeral 1020, one or more visualizations are generated based on the one or more determined characteristics. The visualizations can correspond to charts, graphs, maps, or timelines, among others, appropriate for a particular characteristic. In addition, mechanisms can be presented for invocation, such as a sort mechanism to sort data presented or a search mechanism to search for specific data presented. Further, multiple visualizations can be generated for a characteristic. A user may be able to specify which one or more visualizations are preferred visualizations, for instance based on data type, and optionally plug in custom visualizations. Further, selections and interactions can be synchronized across visualizations.

At numeral 1030, a selection signal can be received, from an input device (e.g., mouse, touchscreen, microphone, camera), with respect to a visualization. For example, an element of the visualization corresponding to one or more values can be selected. In one instance an element can be selected by dragging and dropping the element onto a work area or canvas. In another instance, an element can be selected by positioning a pointing device marker over an element. Other manners of interaction can include displaying an interactive button, presenting a control mechanism upon hovering over an element, and an action menu like ribbon applied to a selected element, among other things.

Based on the selection, and more specifically, selected data or characteristic of data, a filter condition can be automatically generated at reference numeral 1040. The condition can be inclusionary or exclusionary based on the selection. By way of example, selection of a particular value from a column of data can result in a filter condition or criterion that indicates that all rows that include the value in the column are to be included or excluded from a filtered result.

At numeral 1050, one or more generated filter conditions are output. In one instance, the filter conditions can be output to a user interface for display. Additionally or alternatively, the filter conditions can be output to another program or component thereof such as a query builder, wherein the filter conditions form part of the query.

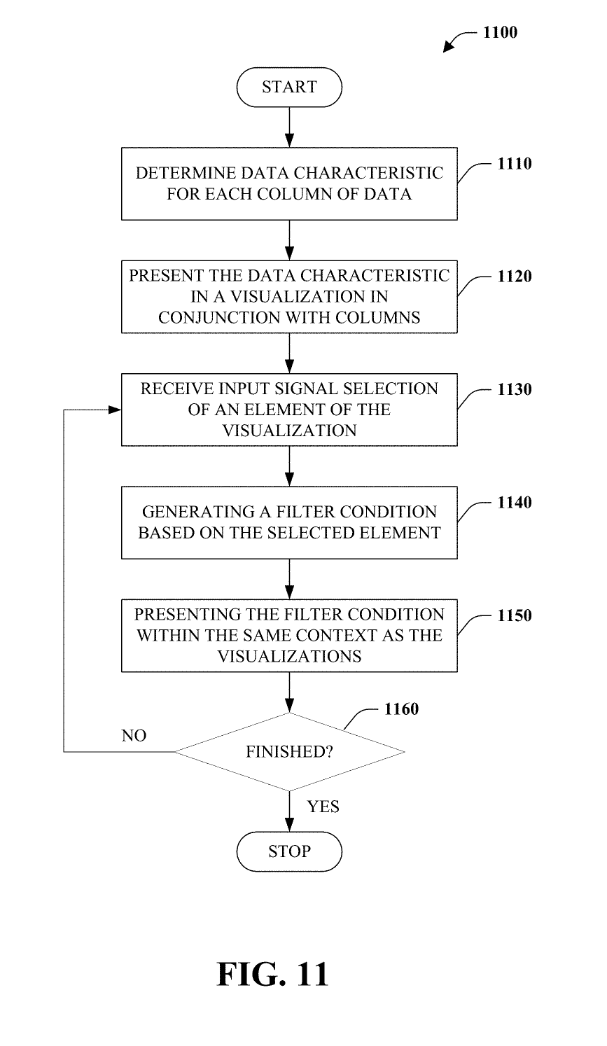

FIG. 11 is a flow chart of a method 1100 of building a filter. At reference numeral 1110, a data characteristic is determined for each column of data in a tabular data set or a subset of columns. The characteristic can correspond to any attribute, property, quality, or feature that is descriptive of a data in a column including the distribution or a pattern of data in the column. For example, the data characteristic can correspond to unique values or frequency of unique values.

At numeral 1120, the data characteristic is presented in a visualization in conjunction with columns. More specifically, a visualization of a data characteristic can be embedded within a respective column visualization to indicate the data visualization corresponds to data of the respective column. Among other things, the data visualization can be a chart, graph, timeline, or map. The visualization can include multiple selectable visualizations presenting the data characteristics in different manners. Additionally, visualizations can be provided that enable invocation of one or more operations on the data characteristic such as sort or search.

At reference numeral 1130, an input signal is received, from an input device (e.g., mouse, touchscreen, microphone, camera), selecting an element of the data visualization. Although not limited thereto, in one instance selection can correspond to a drag-and-drop operation, wherein an element is selected, dragged, and dropped onto a work area. Other interactive mechanisms are also possible and contemplated including display of a button configured to execute an action, presentation of a control upon hovering over an element, and an action menu like ribbon applied to an otherwise identified element, among other things. The selected element of the visualization can represent a value in a column.

At reference numeral 1140, a filter condition is automatically generated based on the selected element and value represented thereby. The filter condition can be explicitly inclusive or exclusive. For instance, the filter can indicate that all rows of tabular data that include a particular value in a particular column are included or excluded from a filtered result.

At reference numeral 1150, the generated filter condition is presented in the same context, such as the same window, as the data visualizations. Overall, an interface progresses from an initial state, to a selection state to a response state in which filter is presented. Further, the filter conditions can be presented in an interactive manner to allow elements of the filter to be changed. For instance, if a filter condition was generated that indicated that a value was to be included within a filtered result and a user later decides that such be excluded, the filter condition can be modified to reflect that intent.

At numeral 1160, a determination is made as to whether or not specification of filter conditions is finished. If filter specification is finished, the method terminates. Otherwise, the method continues at reference numeral 1130 where an input signal selection of another element of the visualization, for instance from the same or different column. Subsequently, a corresponding filter is generated at 1140 and presented at 1150. Two or more conditions can be combined or related by a logical operator (e.g., AND, OR . . . ). Accordingly, a mechanism, such as a drop-down menu, can be presented to allow specification, or change if automatically generated, of a logical operator with respect to two or more filter conditions.

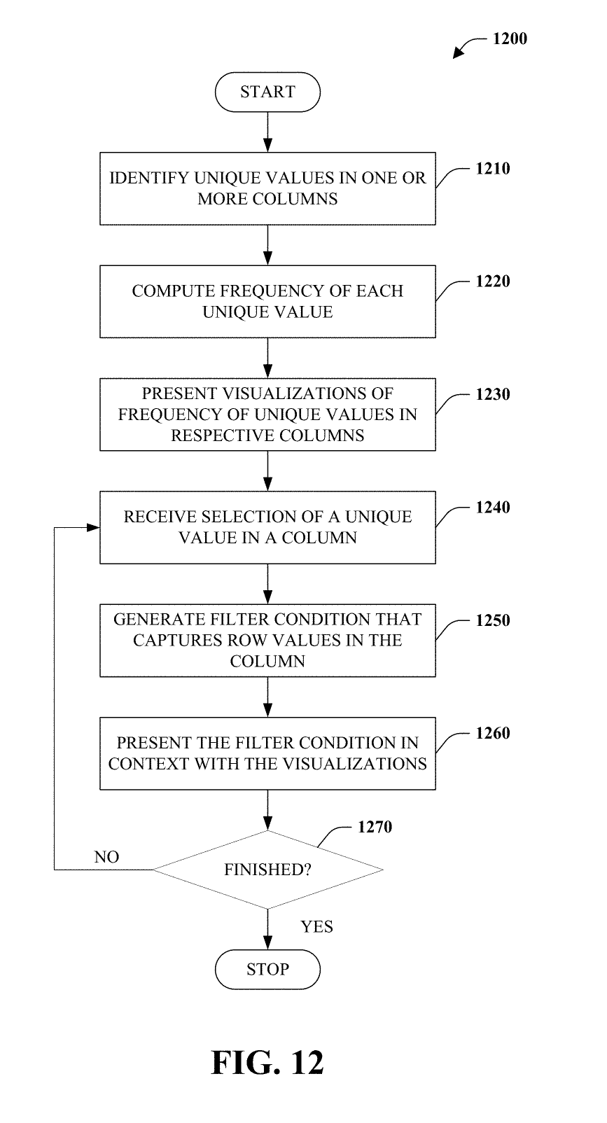

FIG. 12 is a flow chart diagram depicting a method 1200 of filter building in conjunction with frequency distribution. At numeral 1210, unique or distinct values are identified for one or more columns of a tabular data set. For example, each value of a column can be read and any value that has not been read previously captured in a data structure such as list or table.

At numeral 1220, the frequency of each unique value is computed. In other words, the number of occurrences of a value in a column is determined. In accordance with one implementation, a frequency table can be generated that identifies the unique value and number of occurrences.

At reference numeral 1230, a visualization of the frequency of unique values are presented in respective columns. For instance, a bar graph can be employed to represent the number of frequency of each unique value. Further, the bar graph can be embedded in a visualization of a corresponding column to indicate visually that the bar graph represents data of the column.

At reference numeral 1240, selection of a unique value in a column is received. Using an input device, such as a mouse, touchscreen, microphone, or camera, the value can be selected. Although not limited thereto, in accordance with one aspect section can correspond to dragging and dropping the unique value onto a work area or canvas. Other interactive mechanism can also include, without limitation, a control that appears for selection upon hovering a pointing device marker over a value, and a button proximate to a value for selection.

At numeral 1250, a filter condition is automatically generated that captures row values in the column. In other words, the filter condition specifies that rows that include the selected value in the column are included within a filtered result. When dealing with selection of a single element, a single filter condition can be generated. However, if more than one element is selected multiple filter conditions can be generated with a logical operator (e.g. “AND” “OR”) specifying the relationship between the filter conditions.

At reference numeral 1260, the generated filter condition is presented in context with the visualizations. Stated differently, the filter condition is in the same window and/or tab as the visualizations such that a user need not switch visual context to view the filter conditions. For example, the filter condition can be presented on a work area or canvas in the top half of half of a window while the visualizations are displayed in the bottom half of the window.

A determination is made at numeral 1270 as to whether the specification of filter conditions is finished. If specification of filter conditions is finished (“YES”), the method terminates. Otherwise (“NO”), the method returns to reference numeral 1240, where another unique value in a column is selected. Next, a corresponding second filter condition can be generated, which together with the first filter condition can be termed a filter expression. The second filter condition can be presented in proximity to the first filter condition as well as a logical operator (e.g., “AND,” “OR” . . . ) that expresses a relationship between the first and second filter conditions. For example, if the first and second filter conditions correspond to values in the same column, a logical “OR” operator can be presented, and if the first and second filter operators related to values in different columns, a logical “AND” operator can be presented.

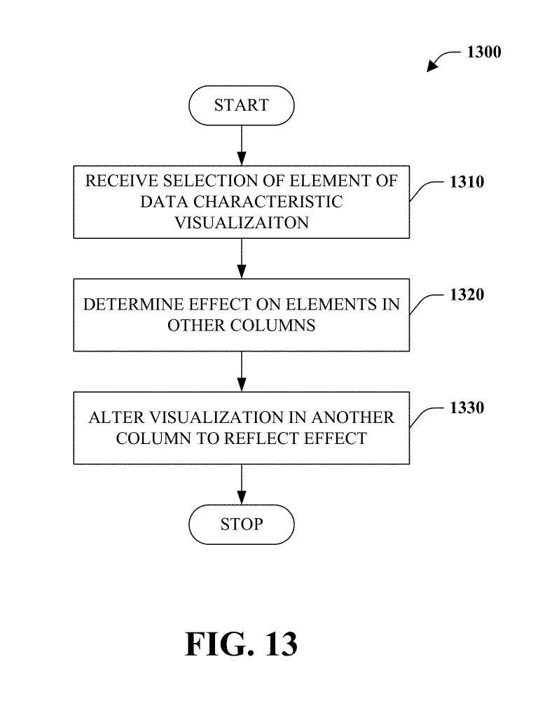

FIG. 13 is a flow chart diagram of a method of providing feedback 1300 in conjunction with filter building. At reference numeral 1310, selection of an element of data characteristic visualization is received. For example, selection of a value displayed in a chart or graph can be received. At numeral 1320, an effect of the selection on other columns or divisions of data is determined. For example, if a value in a second column is to be excluded, such that rows that include the value in the second column are excluded, this can affect data of a first column, namely by eliminating some values. Similarly, if a value in the second column is selected for inclusion in a filtered result, data in the first column can be effected. In particular, the data is also selected by virtue of including the value in the second column. At reference numeral 1330, a visualization in another column, or division of data, is altered to reflect the effect. By way of example, a bar in a graph indicating the frequency of a unique value in a first column can be reduced and/or visualized differently (e.g., different shading) to indicate the determined effect of selection of a value in a second column. Further, in accordance with one aspect, the different portion of the bar indicating the effect can be selected by a user for filter building. For instance, if a bar includes a visually distinct portion of a bar indicating that values are excluded, a user can select that visually distinct portion for re-inclusion in a filtered result despite being excluded by another filter condition.

Aspects of the subject disclosure pertain to the technical problem of data refinement, namely locating relevant data and excluding irrelevant data in a data set. The technical features associated with addressing this problem involve at least determining data characteristics that describe data or the distribution thereof, for example in columns of tabular data, visualizing the data characteristics, and automatically generating filter conditions and/or expressions based on selection of elements of the visualizations. Accordingly, aspects of the disclosure exhibit technical effects including improved efficiency and error resistance associated with data refinement. The visualizations also provide valuable insight that reduces cognitive burden of user associated with filter specification.

The subject disclosure supports various products and processes that perform, or are configured to perform, various actions regarding data characteristic guided filter building. What follows are one or more exemplary methods and systems.

A method comprises determining automatically, by a processor, a characteristic that describes data of a column of a tabular data set; generating a visualization of the characteristic in conjunction with the column; receiving a selection signal from an input device selecting an element of the visualization; and generating a filter condition automatically based on the selected element. Determining a characteristic comprises determining a characteristic that describes distribution of data in the column and determining frequency distribution of unique values. Determining frequency distribution comprises generating a frequency distribution table. The method further comprises sorting elements of the visualization by frequency and disclosing a quantity of instances of one of the unique values in response to a pointer hovering over a visualization element of one or the unique values. In one instance receiving a selection signal comprises dragging and dropping an element of the visualization to a work area in the same context as the visualization. The method further comprises receiving a second selection signal from the input device selecting a second element of the visualization; generating a second filter condition based on the second selected element; and combining the filter condition and the second filter condition with an “OR” operator. The method further comprises receiving a second selection signal from the input device selecting a second element of a second column; generating a second filter condition based on the second selected element; and relating the filter condition and the second filter condition with a logical operator. Furthermore, the method comprises determining an effect of the filter condition on another element of the visualization; and altering the visualization of the another element to reflect the effect. The method further comprises determining a quantity of items filtered by the filter condition, and presenting the quantity in conjunction with the filter choice. The method further comprises sorting elements of the visualization in response to a received sort signal.

A system comprises a processor coupled to a memory, the processor configured to execute computer-executable instructions stored in the memory that when executed perform the following acts: determining a characteristic that describes distribution of data in a column of a tabular data set; generating a visualization of the characteristic in conjunction with the column; receiving a selection signal from an input device selecting an element of the visualization; and generating a filter condition based on the selected element. Determining a characteristic further comprises determining frequency distribution of unique values. The system further comprises disclosing a quantity of instances of one of the unique values in response to a pointer hovering over a visualization element of the one of the unique values. The system of further comprises: receiving a second selection signal from the input device selecting a second element of a second column; generating a second filter condition based on the second selected element; and relating the filter condition and the second filter condition with a logical operator.

The word “exemplary” or various forms thereof are used herein to mean serving as an example, instance, or illustration. Any aspect or design described herein as “exemplary” is not necessarily to be construed as preferred or advantageous over other aspects or designs. Furthermore, examples are provided solely for purposes of clarity and understanding and are not meant to limit or restrict the claimed subject matter or relevant portions of this disclosure in any manner. It is to be appreciated a myriad of additional or alternate examples of varying scope could have been presented, but have been omitted for purposes of brevity.

A computer-readable storage medium having instructions stored thereon that enable at least one processor to perform a method upon execution of the instructions, the method comprises: determining a characteristic that describes distribution of data of a first column of tabular data; presenting a visualization of the characteristic in a graphical user interface within a visual representation of the first column; receiving an input signal from an input device selecting an element of the visualization; generating a filter condition based on the selected element; and presenting the filter condition within a work area in the graphical user interface in the same visual context as the visualization of the characteristic. The computer-readable storage medium further comprises: determining a second characteristic that describes distribution of data of a second column of the tabular data; presenting a second visualization of the second characteristic in the graphical user interface within a visual representation of the second column; receiving an input signal from the input device selecting a second element of the second visualization; generating a second filter condition based on the selected second element; and presenting the second filter condition within the work area with an option to relate the second filter condition with the filter condition with a logical operator. The computer-readable storage medium further comprises: determining an effect of the filter condition on the second characteristic; and altering the visualization of the second visualization to reflect the effect. The computer-readable storage medium further comprises: determining a quantity of items filtered by the filter condition; and presenting the quantity in conjunction with the filter condition in the work area.

As used herein, the terms “component” and “system,” as well as various forms thereof (e.g., components, systems, sub-systems . . . ) are intended to refer to a computer-related entity, either hardware, a combination of hardware and software, software, or software in execution. For example, a component may be, but is not limited to being, a process running on a processor, a processor, an object, an instance, an executable, a thread of execution, a program, and/or a computer. By way of illustration, both an application running on a computer and the computer can be a component. One or more components may reside within a process and/or thread of execution and a component may be localized on one computer and/or distributed between two or more computers.

The conjunction “or” as used in this description and appended claims is intended to mean an inclusive “or” rather than an exclusive “or,” unless otherwise specified or clear from context. In other words, “‘X’ or ‘Y’” is intended to mean any inclusive permutations of “X” and “Y.” For example, if “‘A’ employs ‘X,’” “‘A employs ‘Y,’” or “‘A’ employs both ‘X’ and ‘Y,’” then “‘A’ employs ‘X’ or ‘Y’” is satisfied under any of the foregoing instances.

Furthermore, to the extent that the terms “includes,” “contains,” “has,” “having” or variations in form thereof are used in either the detailed description or the claims, such terms are intended to be inclusive in a manner similar to the term “comprising” as “comprising” is interpreted when employed as a transitional word in a claim.

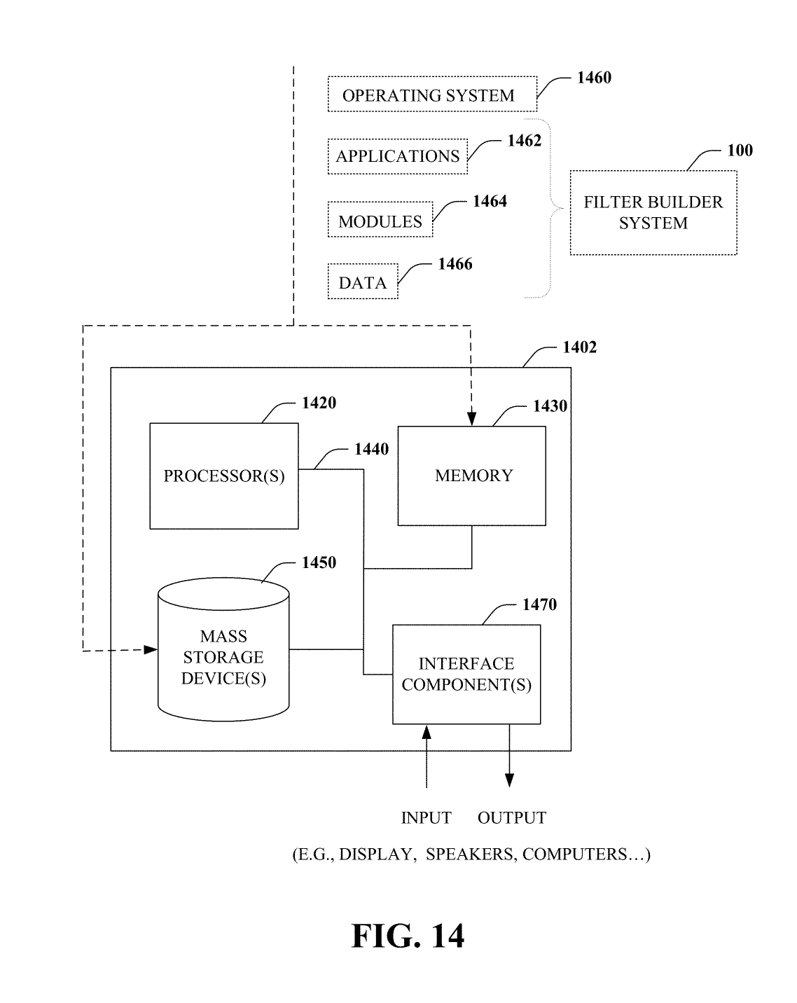

In order to provide a context for the claimed subject matter, FIG. 14 as well as the following discussion are intended to provide a brief, general description of a suitable environment in which various aspects of the subject matter can be implemented. The suitable environment, however, is only an example and is not intended to suggest any limitation as to scope of use or functionality.

While the above disclosed system and methods can be described in the general context of computer-executable instructions of a program that runs on one or more computers, those skilled in the art will recognize that aspects can also be implemented in combination with other program modules or the like. Generally, program modules include routines, programs, components, data structures, among other things that perform particular tasks and/or implement particular abstract data types. Moreover, those skilled in the art will appreciate that the above systems and methods can be practiced with various computer system configurations, including single-processor, multi-processor or multi-core processor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. Aspects can also be practiced in distributed computing environments where tasks are performed by remote processing devices that are linked through a communications network. However, some, if not all aspects of the claimed subject matter can be practiced on stand-alone computers. In a distributed computing environment, program modules may be located in one or both of local and remote memory devices.

With reference to FIG. 14, illustrated is an example general-purpose computer or computing device 1402 (e.g., desktop, laptop, tablet, watch, server, hand-held, programmable consumer or industrial electronics, set-top box, game system, compute node . . . ). The computer 1402 includes one or more processor(s) 1420, memory 1430, system bus 1440, mass storage device(s) 1450, and one or more interface components 1470. The system bus 1440 communicatively couples at least the above system constituents. However, it is to be appreciated that in its simplest form the computer 1402 can include one or more processors 1420 coupled to memory 1430 that execute various computer executable actions, instructions, and or components stored in memory 1430.

The processor(s) 1420 can be implemented with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. The processor(s) 1420 may also be implemented as a combination of computing devices, for example a combination of a DSP and a microprocessor, a plurality of microprocessors, multi-core processors, one or more microprocessors in conjunction with a DSP core, or any other such configuration. In one embodiment, the processor(s) can be a graphics processor.

The computer 1402 can include or otherwise interact with a variety of computer-readable media to facilitate control of the computer 1402 to implement one or more aspects of the claimed subject matter. The computer-readable media can be any available media that can be accessed by the computer 1402 and includes volatile and nonvolatile media, and removable and non-removable media. Computer-readable media can comprise two distinct and mutually exclusive types, namely computer storage media and communication media.

Computer storage media includes volatile and nonvolatile, removable and non-removable media implemented in any method or technology for storage of information such as computer-readable instructions, data structures, program modules, or other data. Computer storage media includes storage devices such as memory devices (e.g., random access memory (RAM), read-only memory (ROM), electrically erasable programmable read-only memory (EEPROM) . . . ), magnetic storage devices (e.g., hard disk, floppy disk, cassettes, tape . . . ), optical disks (e.g., compact disk (CD), digital versatile disk (DVD) . . . ), and solid state devices (e.g., solid state drive (SSD), flash memory drive (e.g., card, stick, key drive . . . ) . . . ), or any other like mediums that store, as opposed to transmit or communicate, the desired information accessible by the computer 1402. Accordingly, computer storage media excludes modulated data signals as well as that described with respect to communication media.

Communication media embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

Memory 1430 and mass storage device(s) 1450 are examples of computer-readable storage media. Depending on the exact configuration and type of computing device, memory 1430 may be volatile (e.g., RAM), non-volatile (e.g., ROM, flash memory . . . ) or some combination of the two. By way of example, the basic input/output system (BIOS), including basic routines to transfer information between elements within the computer 1402, such as during start-up, can be stored in nonvolatile memory, while volatile memory can act as external cache memory to facilitate processing by the processor(s) 1420, among other things.

Mass storage device(s) 1450 includes removable/non-removable, volatile/non-volatile computer storage media for storage of large amounts of data relative to the memory 1430. For example, mass storage device(s) 1450 includes, but is not limited to, one or more devices such as a magnetic or optical disk drive, floppy disk drive, flash memory, solid-state drive, or memory stick.

Memory 1430 and mass storage device(s) 1450 can include, or have stored therein, operating system 1460, one or more applications 1462, one or more program modules 1464, and data 1466. The operating system 1460 acts to control and allocate resources of the computer 1402. Applications 1462 include one or both of system and application software and can exploit management of resources by the operating system 1460 through program modules 1464 and data 1466 stored in memory 1430 and/or mass storage device (s) 1450 to perform one or more actions. Accordingly, applications 1462 can turn a general-purpose computer 1402 into a specialized machine in accordance with the logic provided thereby.

All or portions of the claimed subject matter can be implemented using standard programming and/or engineering techniques to produce software, firmware, hardware, or any combination thereof to control a computer to realize the disclosed functionality. By way of example and not limitation, filter builder system 100, or portions thereof, can be, or form part, of an application 1462, and include one or more modules 1464 and data 1466 stored in memory and/or mass storage device(s) 1450 whose functionality can be realized when executed by one or more processor(s) 1420.

In accordance with one particular embodiment, the processor(s) 1420 can correspond to a system on a chip (SOC) or like architecture including, or in other words integrating, both hardware and software on a single integrated circuit substrate. Here, the processor(s) 1420 can include one or more processors as well as memory at least similar to processor(s) 1420 and memory 1430, among other things. Conventional processors include a minimal amount of hardware and software and rely extensively on external hardware and software. By contrast, an SOC implementation of processor is more powerful, as it embeds hardware and software therein that enable particular functionality with minimal or no reliance on external hardware and software. For example, the filter builder system 100 and/or associated functionality can be embedded within hardware in a SOC architecture.

The computer 1402 also includes one or more interface components 1470 that are communicatively coupled to the system bus 1440 and facilitate interaction with the computer 1402. By way of example, the interface component 1470 can be a port (e.g. serial, parallel, PCMCIA, USB, FireWire . . . ) or an interface card (e.g., sound, video . . . ) or the like. In one example implementation, the interface component 1470 can be embodied as a user input/output interface to enable a user to enter commands and information into the computer 1402, for instance by way of one or more gestures or voice input, through one or more input devices (e.g., pointing device such as a mouse, trackball, stylus, touch pad, keyboard, microphone, joystick, game pad, satellite dish, scanner, camera, other computer . . . ). In another example implementation, the interface component 1470 can be embodied as an output peripheral interface to supply output to displays (e.g., LCD, LED, plasma . . . ), speakers, printers, and/or other computers, among other things. Still further yet, the interface component 1470 can be embodied as a network interface to enable communication with other computing devices (not shown), such as over a wired or wireless communications link.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications, and variations that fall within the spirit and scope of the appended claims.

What is claimed is:

1. A method, comprising:
determining automatically, by a processor, a characteristic that describes data of a column of a tabular data set;
generating a visualization of the characteristic in conjunction with the column;
receiving a selection signal from an input device selecting an element of the visualization; and
generating a filter condition automatically based on the selected element.

2. The method of claim 1, determining a characteristic comprises determining a characteristic that describes distribution of data in the column.

3. The method of claim 2, determining a characteristic comprises determining frequency distribution of unique values.

4. The method of claim 3, determining the frequency distribution comprises generating a frequency distribution table.

5. The method of claim 3 further comprises sorting elements of the visualization by frequency.

6. The method of claim 3 further comprises disclosing a quantity of instances of one of the unique values in response to a pointer hovering over a visualization element of the one of the unique values.

7. The method of claim 1, receiving a selection signal comprises dragging and dropping an element of the visualization to a work area in the same context as the visualization.

8. The method of claim 1 further comprises:
receiving a second selection signal from the input device selecting a second element of the visualization;
generating a second filter condition based on the second selected element; and
combining the filter condition and the second filter condition with an “OR” operator.

9. The method of claim 1 further comprises:
receiving a second selection signal from the input device selecting a second element of a second column;
generating a second filter condition based on the second selected element; and
relating the filter condition and the second filter condition with a logical operator.

10. The method of claim 1 further comprises:
determining an effect of the filter condition on another element of the visualization; and
altering the visualization of the another element to reflect the effect.

11. The method of claim 1 further comprises:
determining a quantity of items filtered by the filter condition; and
presenting the quantity in conjunction with the filter condition.

12. The method of claim 1 further comprises sorting elements of the visualization in response to a received sort signal.

13. A system comprising:
a processor coupled to a memory, the processor configured to execute computer-executable instructions stored in the memory that when executed perform the following acts:
determining a characteristic that describes distribution of data in a column of a tabular data set;
generating a visualization of the characteristic in conjunction with the column;
receiving a selection signal from an input device selecting an element of the visualization; and
generating a filter condition based on the selected element.

14. The system of claim 13, determining a characteristic further comprises determining frequency distribution of unique values.

15. The system of claim 14 further comprises disclosing a quantity of instances of one of the unique values in response to a pointer hovering over a visualization element of the one of the unique values.

16. The system of claim 13 further comprises:
receiving a second selection signal from the input device selecting a second element of a second column;
generating a second filter condition based on the second selected element; and
relating the filter condition and the second filter condition with a logical operator.

17. A computer-readable storage medium having instructions stored thereon that enable at least one processor to perform a method upon execution of the instructions, the method comprising:
determining a characteristic that describes distribution of data of a first column of tabular data;
presenting a visualization of the characteristic in a graphical user interface within a visual representation of the first column;
receiving an input signal from an input device selecting an element of the visualization;
generating a filter condition based on the selected element; and
presenting the filter condition within a work area in the graphical user interface in the same visual context as the visualization of the characteristic.

18. The computer-readable storage medium of claim 17 further comprises:
determining a second characteristic that describes distribution of data of a second column of the tabular data;
presenting a second visualization of the second characteristic in the graphical user interface within a visual representation of the second column;
receiving an input signal from the input device selecting a second element of the second visualization;
generating a second filter condition based on the selected second element; and
presenting the second filter condition within the work area with an option to relate the second filter condition with the filter condition with a logical operator.

19. The computer-readable storage medium of claim 18 further comprises:
determining an effect of the filter condition on the second characteristic; and
altering the visualization of the second visualization to reflect the effect.

20. The computer-readable storage medium of claim 17 further comprises:
determining a quantity of items filtered by the filter condition; and
presenting the quantity in conjunction with the filter condition in the work area.
